(19) United States
(12) Patent Application Publication
(10) Pub. No.: US 2003/0206604 A1
(43) Pub. Date: Nov. 6, 2003

(54) Receiver for baseline wandering compensation

(76) Inventor: Jyh-Ting Lai, Hsinchu (TW)

Correspondence Address: RABIN & CHAMPAGNE, PC, 1101 14TH STREET, NW, SUITE 500, WASHINGTON, DC, 20005, US

(21) Appl. No.: 10/193,302

(22) Filed: Jul. 12, 2002

(30) Foreign Application Priority Data
May 3, 2002 (TW) 91109213

(51) Int. Cl. H04B 1/10

(52) U.S. Cl. 375/350

(57) ABSTRACT

A receiver for baseline wandering compensation. The receiver is capable of correcting for baseline wander and receiving killer packets, and includes an analog-to-digital converter, an equalizer, a slicer and a baseline wander corrector. The analog-to-digital converter is coupled to a transmission channel to receive and digitize input signals and outputs a sample. The equalizer is coupled to the analog-to-digital converter to receive the sample, and outputs an equalized sample. The slicer is coupled to the equalizer to receive the equalized sample, and outputs a symbol based on the equalized sample output from the equalizer. The baseline wander corrector is coupled between the slicer and the equalizer. The baseline wander corrector receives the symbol output from the slicer and the equalized sample output from the equalizer, calculates a baseline correction, and adds the baseline correction to the equalized sample output from the equalizer.

### BACKGROUND OF THE INVENTION

1. Field of the Invention

The present invention relates in general to digital communication systems. In particular, the present invention relates to a receiver for baseline wandering compensation that is able to correct baseline wander in baseband transceiver systems and receive killer packets.

2. Description of the Related Art

The dramatic increase in computing power driven by intranet-based operations and the increased demand for time-sensitive delivery between users has spurred development of high speed Ethernet local area networks (LANs). 100BASE-TX Ethernet (see IEEE Std. 802.3u-1995 CSMA/CD Access Method, Type 100 Base-T) using existing category 5 (CAT-5) copper wire, and the newly developing 1000BASE-T Ethernet (see IEEE Std. 802.3ab Physical Layer Specification for 1000 Mb/s Operation on Four Pairs of Category 5 or Better Twisted Pair Cable (1000 Base-T)) for Gigabit/s transfer of data over category 5 data grade copper wiring, require new techniques in high speed symbol processing. On category 5 cabling, gigabit per second transfer can be accomplished utilizing four twisted pairs and a 125 megasymbol/s transfer rate on each pair where each symbol represents two bits.

Physically, data is transferred using a set of voltage pulses where each voltage represents one or more bits of data. Each voltage in the set is referred to as a symbol and the whole set is referred to as a symbol alphabet.

An alternative well-known modulation method for high speed symbol transfer is MLT3 and involves a three level system. (See American National Standard Information system, Fibre Distributed Data Interface (FDDI)—Part: Token Ring Twisted Pair Physical Layer Medium Dependent (TP-PMD), ANSI X3.263:1995). The MLT3 modulation method could be represented as a “Finite State Machine”. The “Finite State Machine” has four states that are {+0, +1, −0, −1}. The four states circulate in order. When the information that will be transmitted is logic “0”, it will be transmitted in the same state. When the information that will be transmitted is logic “1”, it will be transmitted in the next state. The voltage levels of outputting symbol are 0 V, +1 V, 0 V, −1V for the “+0” state, the “+1” state, the “+0” state and the “−1” state, respectively. Information that will be transmitted, for example, is “000101110”. The outputting symbol for MLT3 is “(0)000110-100”. (0) is an initial symbol. The actual voltage levels that are transmitted are typically +1 V, 0 V and −1 V for the +1 symbol, the 0 symbol and the −1 symbol, respectively.

The detection system in the MLT3 standard needs to distinguish between 3 levels, instead of two levels in a more typical two level system. The signal to noise ratio required to achieve a particular bit error rate is higher for MLT3 system, however, the energy spectrum of the emitted radiation from the MLT3 system is concentrated at lower frequencies and therefore more easily meets FCC radiation emission standards for transmission over twisted pair cables. Other communication systems may use a symbol alphabet having more than two voltage levels in the physical layer in order to transmit multiple bits of data using each individual symbol. In example, 5-level pulse amplitude modulated (PAM) data with partial response shaping is transmitted at a baud rate of 125 Mbaud. (See IEEE Std. 802.3ab Physical Layer Specification for 1000 Mb/s Operation on Four Pairs Of Category 5 or Better Twisted Pair Cable (1000 Base-T)).

FIG. 1 shows a typical transmission system for transmitting data at high rates over conventional twisted copper pair wiring. The transmission system 100 comprises a transmitter 101, a transmit coupler 102, a transmission channel 103, a receive coupler 104 and a receiver 105. The transmitter 101 receives data in the form of a symbol stream from a host 111 through a medium independent interface (MI I) 112 and couples the modulated data into the transmission medium 103 through the transmit coupler 102. The receive coupler 104 receives a modulated waveform from the transmission medium 103 and couples the modulated waveform into the receiver 105. The modulated waveform in the receiver 105 suffers from the effect of channel distortion. After correcting for channel distortion, the receiver 105 outputs received data to host 113 via a medium independent interface 114.

Intersymbol interference can be compensated for by equalization in receiver 105. However, some of the effects resulting from couplers 102 and 104, which are typically transformers, are not compensated adequately by equalization in receiver 105. These effects include baseline wander and killer packets.

Baseline wander refers to the result of a transmission, in baseband transceiver systems, of symbols where most of the symbols are of identical polarity, for example, in MLT3 transmission a long series of ones or negative ones. In that case, the output signal from the transmitter 101 appears to be a DC signal (a constant 1 V is transmitted by the transmitter 101 if a long series of +1 symbols is transmitted). In general, the baseline of the transmit signal is shifted up or down based on the polarity of the transmitted data. The couplers 102 and 104 are typically inductors, and therefore, do not pass DC voltages. The net effect is that the input signal to the receiver 105 suffers an exponential decay, called droop or “baseline wander”, eventually resulting in increased error rates in the receiver if the baseline wander effect is not adequately compensated.

In addition, some particular data sequences result in peak-to-peak voltage levels at the receiver much higher than other data sequences. For example, even though the transmitter 101 outputs a signal having a peak-to-peak voltage of 2 V, because of the effects of the couplers 102 and 104, the input signal at the receiver 105 can be as high as about 4 V peak-to-peak in response to certain sequences of symbols. A sequence of transmitted symbols that results in particularly high peak-to-peak voltages at the receiver 105 is referred to as a “killer packet”.

Corrections for baseline wander and receipt of killer packets have depended on a model of the transformer and have been implemented, at least partially, with analog circuitry. Furthermore, another approach involves a digital baseline wander correction circuit that digitally corrects for baseline wander and is independent of the actual coupling transformers, and a receiver that receives “killer” packets without a subsequent loss of resolution for the analog-to-digital converter. (See Taiwan Patent Number 423243, “Digital Baseline Wander Correction Circuit”, Sreen A. Raghavan)

FIG. 2 shows a receiver according to Raghavan. An input signal {Aᵢ(k)} is input to a transmission channel 10 by a transmitter (not shown). A receiver 200 receives the signal, suffering from channel distortion, random noise, and a flat signal loss and inputs the signal to ananti-aliasing filter 202. Then, the signal is input to an analog-to-digital converter (ADC) 203 to digitize the signal. The digitized signal is corrected by subtracting a baseline wander correction Bₖ in an adder 212 and amplified in an amplifier 201. The amplified signal is equalized in an equalizer 204. Then, an output signal {Aₒ(k)} is determined by a slicer 205. A wander correction element 211 receives the signal outputting from the slicer 205 and the signal inputting to the slicer 205 to determine the amount of the baseline correction Bₖ. An ADC reference voltage circuit 213, based on an indication of the cable length, adjusts the reference voltage of the ADC 203 in preparation for receiving “killer” packets. An adaptation circuit 206 determines the equalizer coefficients of the equalizer 204. A gain control circuit 208 determines the gain g of the amplifier 201. A timing recovery circuit 207 tracks the timing of the circuit and adjusts the timing phase τ for the sample and hold function of the ADC 203.

In the receiver 200, after correction by subtracting the baseline wander correction Bₖ in the adder 212, the digitized signal is amplified in the amplifier 201. Then, the amplified signal is equalized in the equalizer 204. Thus, before input to the equalizer 204, the digitized signal subtracts the baseline wander correction Bₖ in the adder 212. Because bit number is small after the ADC (typically 6-9 bits), the receiver 200 has a large quantization error.

As well, in the receiver 200, the digitized signal is corrected by subtracting the baseline wander correction Bₖ in the adder 212. But the amount of the baseline correction Bₖ is determined by the wander correction element 211 receiving the signal outputting from the slicer 205 and the signal inputting to the slicer 205. Therefore, the system has long loop delay. With the long loop delay, when receiving “killer” packets, the system will start oscillating. Then, the system may lose stability.

### SUMMARY OF THE INVENTION

An object of the present invention is to provide a receiver for baseline wandering compensation that is able to correct baseline wander in baseband transceiver systems and receive killer packets with lower quantization error and shorter loop delay.

Another object of the present invention is to provide a receiver for baseline wandering compensation that is able to give the output of the receiver better equalized effect and maintain a stable system when receiving killer packets.

The receiver for baseline wandering compensation of the present invention comprises an analog-to-digital converter, an equalizer, a slicer, and a baseline wander corrector. The analog-to-digital converter is coupled to a transmission channel to receive and digitize input signals and outputs a sample. The equalizer is coupled to the analog-to-digital converter to receive the sample. The equalizer outputs an equalized sample. The slicer is coupled to the equalizer to receive the equalized sample. The slicer outputs a symbol based on the equalized sample output from the equalizer. The baseline wander corrector is coupled between the slicer and the equalizer. The baseline wander corrector receives the symbol output from the slicer and the equalized sample output from the equalizer, calculates a baseline correction, and adds the baseline correction to the equalized sample output from the equalizer.

As mentioned above, the baseline wander corrector comprises a wander compensation circuit and an adder. The wander compensation circuit receives the symbol and the equalized sample. The wander compensation circuit outputs a baseline correction signal with the baseline correction. The adder is coupled between the slicer and the equalizer. The adder receives the equalized sample output from the equalizer and the baseline correction signal output from the wander compensation circuit, and outputs a signal equal to the equalized sample output from the equalizer corrected by the baseline correction.

Lastly, the wander compensation circuit digitally implements a transfer function equal to K/(1−Z⁻¹), wherein K is a constant and Z⁻¹ represents a Z transform of a one period delay.

### BRIEF DESCRIPTION OF THE DRAWINGS

The present invention can be more fully understood by reading the subsequent detailed description in conjunction with the examples and references made to the accompanying drawings, wherein:

FIG. 1 shows a typical transmission system for transmitting data at high rates over conventional twisted copper pair wiring;

FIG. 2 shows a block diagram of receiver according to Raghavan;

FIG. 3 shows a block diagram of a receiver for baseline wandering compensation according to a first embodiment of the invention;

FIG. 4 shows a schematic diagram illustrating the relation between an input level of the slicer and an output level of the slicer according to the first embodiment of the invention;

FIG. 5 shows an example symbol packet that is susceptible to baseline wander and the droop that results from that symbol packet;

FIG. 6 shows a block diagram of an example of the a baseline wander corrector according to the first embodiment of the invention;

FIG. 7 shows a block diagram of a receiver for baseline wandering compensation according to the second embodiment of the invention;

FIG. 8A is an eye diagram of a signal output from a receiver without any baseline wander correction circuit;

FIG. 8B is an eye diagram of a signal output from a prior receiver according to Raghavan; and

FIG. 8c is an eye diagram of a signal output from a prior receiver according to the first embodiment of the present invention.

### DETAILED DESCRIPTION OF THE INVENTION

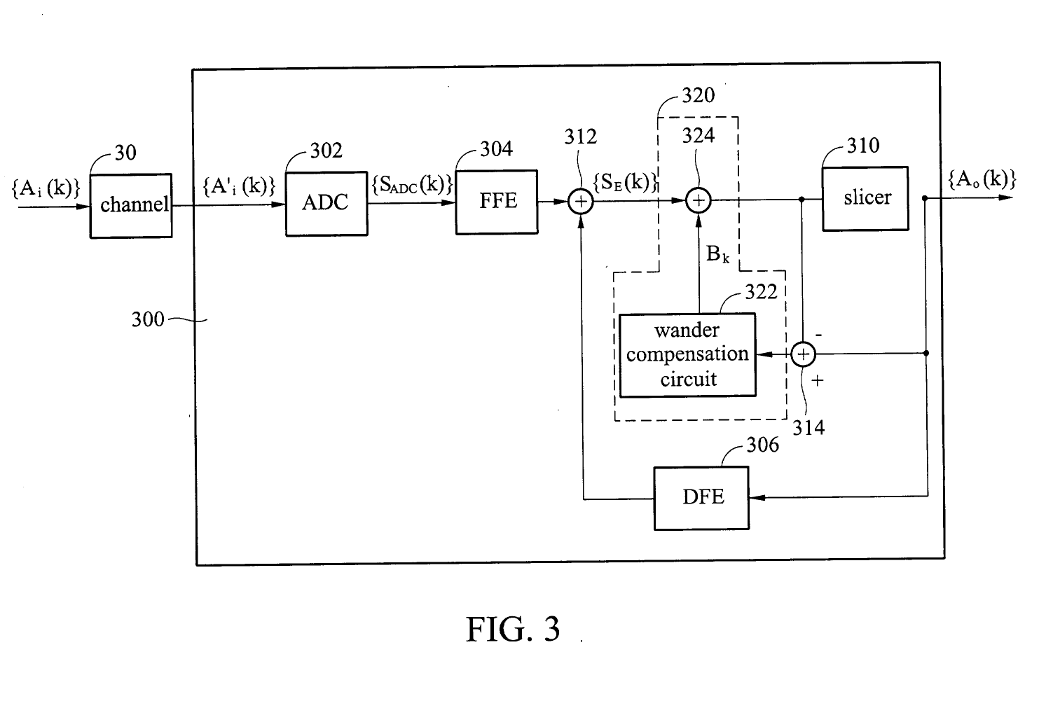

FIG. 3 shows a block diagram of a receiver for baseline wandering compensation according to a first embodiment of the invention. The receiver for baseline wandering compensation 300 comprises an analog-to-digital converter (ADC) 302, a feedforward equalizer (FFE) 304, a decision feedback equalizer (DFE) 306, a slicer 310 adders 312 and 314, and a baseline wander corrector 320.

An input symbol stream {Aᵢ(k)} is input to a transmission channel 10 by a transmitter (not shown). The analog-to-digital converter 302 is coupled to the transmission channel 30. The signal is input to the analog-to-digital converter 302 to digitize the signal. The symbol stream {Aᵢ(k)} suffer from channel distortion, random noise, and a flat signal loss and baseline wandering in the transmission channel 30 to become a input symbol {A′ᵢ(k)} received by the receiver 300. In the embodiment of the present invention, the symbol stream {Aᵢ(k)} is MLT3 symbol alphabet. The transmitted symbols in the sequence {Aᵢ(k)} are members of the symbol alphabet {A}. In the case of three level MLT3 signaling, the symbol alphabet {A} is given by {−1, 0, +1}. The index k represents the time index for that symbol, i.e. at sample time k, the symbol being transmitted to transmission channel 30 is given by A(k).

After receiving the input symbol {A′ᵢ(k)}, the analog-to-digital converter 302 digitizes it and outputs a sample {S_{ADC}(k)} to the equalizer. Typically, a signal transmitted through the cannel is hampered by various sources of signal degradation. One such source is intersymbol interference where consecutive transmitted symbols interfere with each other. Other sources of signal degradation include the transmission media (i.e. wire) and analog filters. These factors produce large amplitude and group delay distortion in the signal that needs compensation. To compensate for intersymbol interference (ISI) and other sources of signal degradation and distortion, best performance is achieved by implementing an equalizer. In the embodiment of the present invention, the feedforward equalizer 304 and decision feedback equalizer 306 provides with the function of equalization. The feedforward equalizer 304 receives the sample output from the analog-to-digital converter 203. The decision feedback equalizer 306 receives the symbol output from the slicer 310. And, the adder 312 receives the output of the decision feedback equalizer 306 and the output of the feedforward equalizer 304 to determine an equalized sample {S_{E}(k)}.

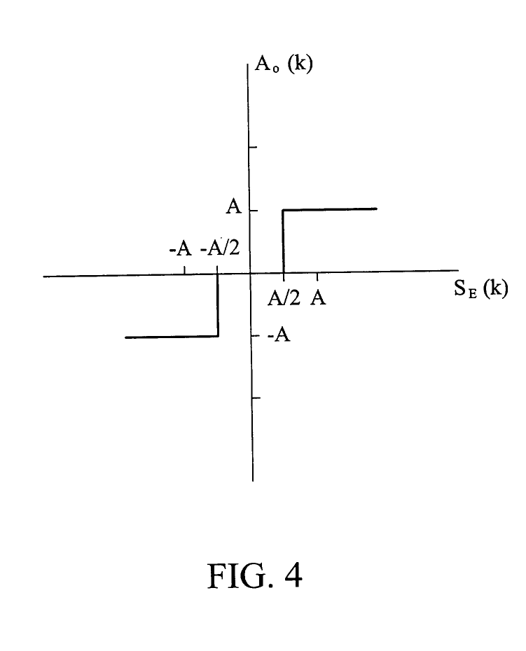

The equalized sample {S_{E}(k)} is input to the slicer 310. The slicer 310 determines an output symbol {Aₒ(k)} based on the equalized sample {S_{E}(k)}. The relation between an input level of the slicer 310 and an output level of the slicer 310 is referred to FIG. 4. After subtracting the equalized sample {S_{E}(k)} in the adder 314, the output symbol {Aₒ(k)} is received by the baseline wander corrector 320.

The baseline wander corrector 320 comprises a wander compensation circuit 322 and an adder 324. The wander compensation circuit 322 is coupled between the adder 314 and the adder 324. The wander compensation circuit 322 receives the output of the adder 314 to calculate the baseline correction Bk. At the next sample time i.e. sample time (k+1), the baseline correction Bₖ is added to the equalized sample (S_{E}(k+1)) by the adder 324 to correct the baseline wander.

The following illustrates how adding the baseline correction to the equalized sample output from the equalizer can correct the baseline wander in the present invention.

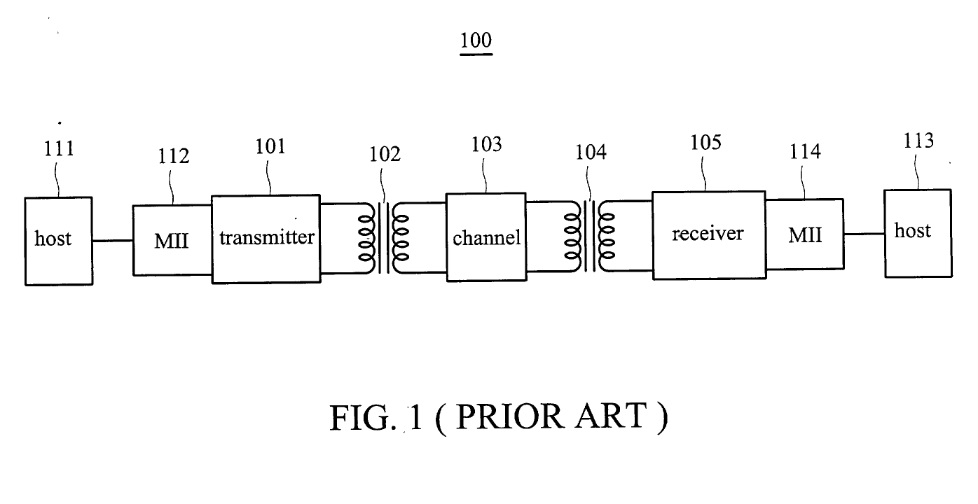

A time constant of the baseline wander is assumed to be 1000 ns. A sample time is also assumed to be 8n. Because the time constant of the baseline wander is much higher than the sample time, the baseline wander can be seen as a direct current signal. The direct current signal is also assumed to be D (k). It is also assumed that a signal transmitting through a channel but not through a transformer (see 102 and 104 in FIG. 1),i.e. a normal signal without the baseline wander, is Aᵤ(k). Then, the symbol A′ᵢ(k) received by the receiver is given by

A′ᵢ(k)=D(k)+Aᵤ(k)

A transform function of the feedforward equalizer is assumed to be F(k). A coefficient of the feedforward equalizer is also assumed to be C_{if}. Then, the equalized sample S_{E}(k) output from the feedforward equalizer is given by

$$\begin{matrix}{S}_{E} ( k ) = {A}_{i}^{′} ( k ) * F ( k ) = [ D ( k ) + {A}_{u} ( k ) ] * F ( k ) \\ = D ( k ) * F ( k ) + {A}_{u} ( k ) * F ( k )\end{matrix} \qquad ( 1 )$$

The D(k) is a constant, “*” is the function operation of convolution, so

$$D ( k ) * F ( k ) = {}_{i = 1}^{n + 1} {C}_{if} ( i ) D ( k ) = D {}_{i = 1}^{n + 1} {C}_{if} ( i ) \qquad ( 2 )$$

After equalizing, the coefficient of the feedforward equalizer C_{if} becomes a constant. Therefore, the equation (2) becomes a fixed value. The equation (1) can be rewritten as

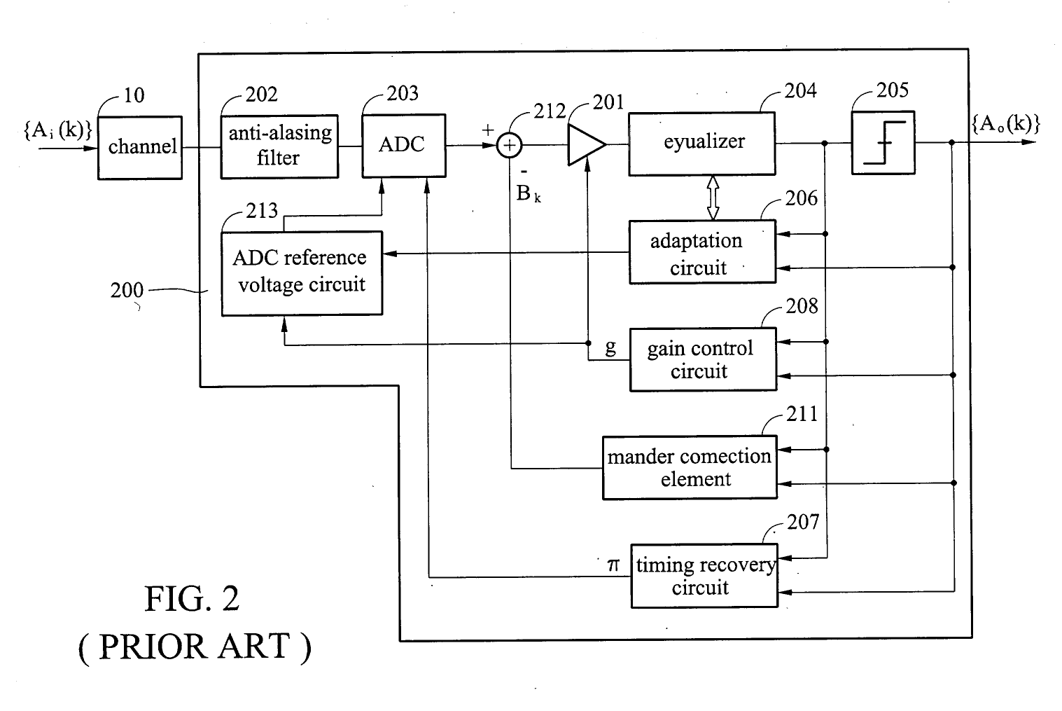

S_{E}(k)=D(k)*F(k)+C

where C is a constant. The constant C is the baseline wander. Therefore, the baseline wander can be corrected by adding the baseline correction to the equalized sample output from the feedforward equalizer. It is not required to correct the baseline wander before inputting the equalized sample, as with the receiver according to Raghavan (see FIG. 2).

FIG. 4 shows a schematic diagram illustrating the relation between input of the slicer and output of the slicer according to the first embodiment of the invention. The cross axis represents the input of the slicer r_{I}(n) i.e. the equalized sample {S_{E}(k+1)}. The vertical axle represents the output of the slicer r_{O}(n) i.e. the output symbol {Aₒ(k)}. A/2 and −A/2 are slicing levels of the slicer 310. While the level for the input of the slicer r_{I}(n) is higher than the slicing level A/2, the level for the output of the slicer r_{O}(n) is A. While the level for the input of the slicer r_{I}(n) is lower than the slicing level −A/2, the level for the output of the slicer r_{O}(n) is −A. While the level for the input of the slicer r_{I}(n) is between the slicing level −A/2 and A/2, the level for the output of the slicer r_{O}(n) is zero. In the embodiment of the invention using MLT3 symbols, the slicing levels A/2 and −A/2 are separately 0.5 and −0.5. These levels for the output of the slicer are separately +1.0, 0.0 and −1.0. The output of the slicer r_{O}(n) i.e. the output symbol {Aₒ(k)} is given by

$${A}_{0} ( k ) = \{ \begin{matrix}1 & {S}_{E} ( k ) > 0.5 \\ 0 & - 0.5 < {S}_{E} ( k ) < 0.5 \\ - 1 & {S}_{E} ( k ) < - 0.5\end{matrix}$$

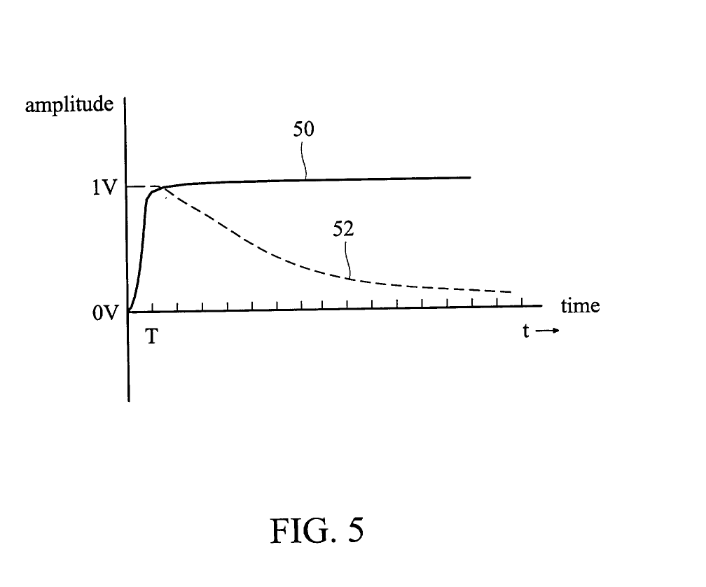

FIG. 5 shows an example symbol packet that is susceptible to baseline wander and the droop that results from that symbol packet. A logic series (“1”, “0” “0”, . . . , “0”) is modified by the MLT3 modulation. The series of MLT3 symbols to transmit the logic series (“1”, “0”, “0”, . . . , “0”) are {A}={1, 1, . . . , 1}. The seires is a function of time k. Every period T, one symbol of {A} is sent as a +1 V signal. The symbol stream transmitted by the transmitter 101 (see FIG. 1) appears as a constant 1 V. Transformers 102 and 104 (see FIG. 1), however, act as high-pass filters and do not pass DC voltages. The actual voltage received at receiver 105, therefore, decays with time. The exponential decay, called droop or “baseline wander”, eventually resulting in increased error rates in the receiver if the baseline wander effect is not adequately compensated. The voltage 50 of the symbol stream transmitted by the transmitter 101 is shown in FIG. 5 as a real line. The actual voltage 52 received at receiver 105 is shown in FIG. 5 as a dashed line. The voltage sample received at the receiver 300 (see FIG. 3) of the present invention, under these conditions, droops at the rate of

$${V}_{k} = {V}_{0} {ⅇ}^{- 2 π \cdot \frac{{F}_{3 dB}}{{f}_{s}} \cdot k}$$

where F₃ dB is the bandwidth of the transformer, fₛ is the sampling rate and k is the symbol number in the constant series.

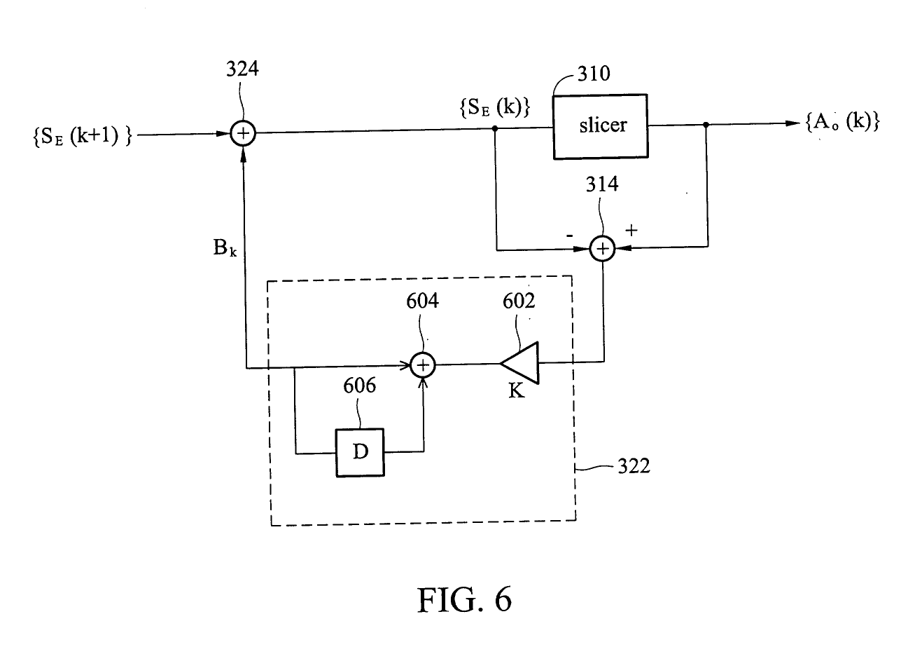

FIG. 6 shows a block diagram of an example of the baseline wander corrector according to the first embodiment of the invention. The wander compensation circuit 322 is coupled between the adder 314 and the adder 324. The wander compensation circuit 322 receives the output of the adder 314, i.e. the difference between the output symbol {Aₒ(k)} of the slicer 310 and the equalized sample {S_{E}(k)}, to calculate the baseline correction Bₖ. At the next sample time i.e. sample time (k+1), the baseline correction Bₖ is added to the equalized sample {S_{E}(k+1)} by the adder 324 to correct the baseline wander. The wander compensation circuit 322 comprises an amplifier 602, an adder 604 and a delay unit 606. An amplification of the amplifier 602 is K. The wander compensation circuit 322 executes the Z transform function

H(Z)=K/(1−Z⁻¹)

where K is a constant which controls the response time of the wander compensation circuit 322 and Z⁻¹ represents a Z transform of a one period delay.

In FIG. 6, the baseline correction is Bₖ. If the system has the baseline wander, the baseline correction Bₖ is added to the next equalized sample. In the present invention, the baseline correction Bₖ is added to the output of the equalizer to correct the baseline wander. For example, in the embodiment shown in FIG. 3, the baseline correction Bₖ is added to the equalized sample {S_{E}(k+1)}, the adding result of the output of the decision feedback equalizer 306 and the output of the feedforward equalizer 304. This way is a digitally implemented correction for the output of the equalizer. Therefore, the performance of the operation for all kinds of “killer” packets and random information is good. The operation can also address small arithmetic errors of digitally channels.

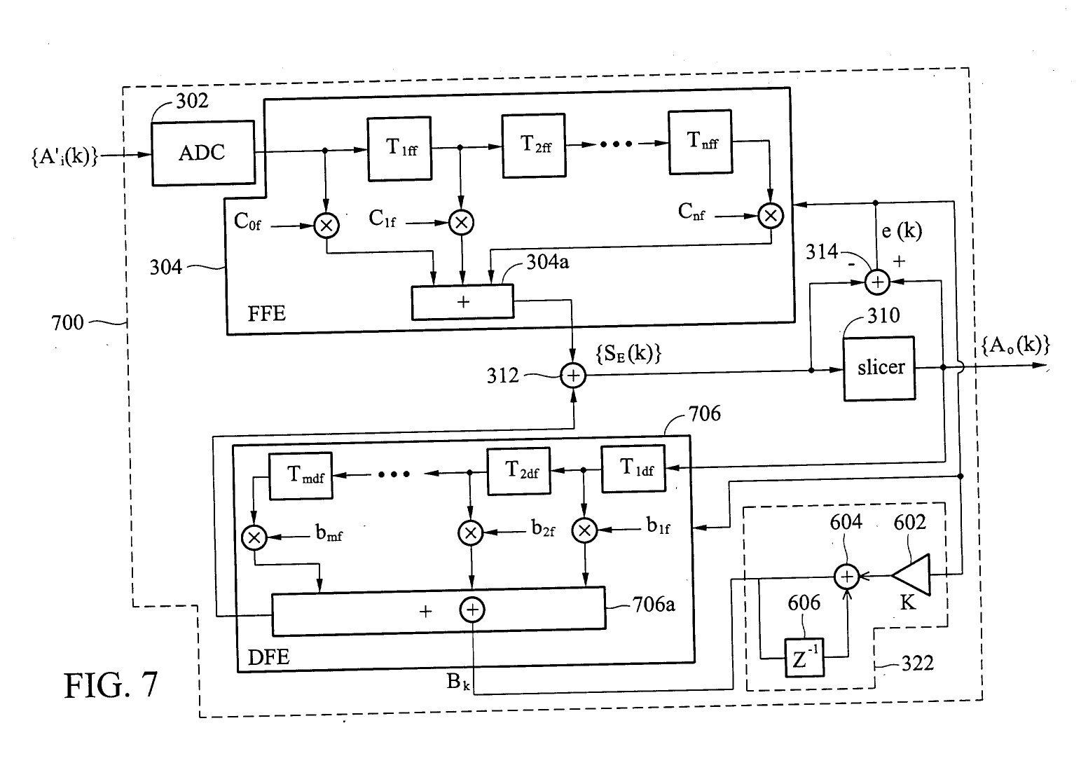

FIG. 7 shows a block diagram of a receiver for baseline wandering compensation according to the second embodiment of the invention. The receiver for baseline wandering compensation 700 comprises an analog-to-digital converter (ADC) 302, a feedforward equalizer (FFE) 304, a decision feedback equalizer (DFE) 706, a slicer 310 adders 312 and 314, and a baseline wander corrector 320. The architecture in FIG. 7 is basically the same as in FIG. 3, with the difference that the decision feedback equalizer 706 in the embodiment of the present invention implements the part function of the baseline wander corrector 320. Actually, an adder in the decision feedback equalizer realizes the function of the adder 324 (see FIG. 3).

The detailed specification of the analog-to-digital converter 302, feedforward equalizer 304, slicer 310, adders 312 and 314 is referred to the specification of FIG. 3.

To distinguish between the first embodiment shown in FIG. 3 and this embodiment, the detailed interior architecture of the feedforward equalizer 304 and decision feedback equalizer 706 is drawn in FIG. 7. The feedforward equalizer 304 comprises n delay units T_{1ff}˜T_{nff}, (n+1) multipliers and one adder 304a. Each output of the delay units T_{1ff}˜T_{nff} is separately multiplied by one of factors C_{of}˜C_{nf} input to the multipliers to produce a multiplied result. The adder 304a receives all multiplied results to add and outputs an added result from the feedforward equalizer 304. An error correction E (k) of the equalizer output from the slicer 310 adjusts the factors C_{of}˜C_{nf}. The decision feedback equalizer 706 comprises m delay units T_{1df}˜T_{mdf}, m multipliers and one adder 706a. Each output of the delay units T_{1df}˜T_{mdt} is separately multiplied by one of factors b_{1f}˜b_{mf} input to the multipliers to produce a multiplied result. The adder 706a receives all multiplied results to add them and outputs an added result from the decision feedback equalizer 706. The error correction E(k) of the equalizer output from the slicer 310 adjusts the factors b_{1f}˜b_{mf}.

The wander compensation circuit 322 receives the output of the adder 314, i.e. the difference between the output symbol {Aₒ(k)} of the slicer 310 and the equalized sample {S_{E}(k)}, to calculate the baseline correction Bₖ. The wander compensation circuit 322 comprises an amplifier 602, an adder 604 and a delay unit 606 which execute the Z transform function

H(Z)=K/(1−Z⁻¹)

where K is a constant which controls the response time of the wander compensation circuit 322 and Z⁻¹ represents a Z transform of a one period delay.

The adder 706b of the decision feedback equalizer 706 receives the baseline correction Bₖ through the wander compensation circuit 322 to correct the baseline wander. In the embodiment of the present invention, the adder 706a can perform the function of the adder 324 in FIG. 3., i.e. the baseline correction Bₖ is added to the equalized sample by the adder 324 to correct the baseline wander. Therefore, in the embodiment, the adder 324 is not required.

Comparison between the present invention and prior art is shown in FIG. 2 and FIG. 3. In the receiver of the present invention (see FIG. 3), the baseline correction is added to the output of the equalizer. The receiver has lower quantization error and shorter loop delay than the prior receiver. Therefore, the output of the receiver has better equalized effect and the system maintains stability even when receiving killer packets.

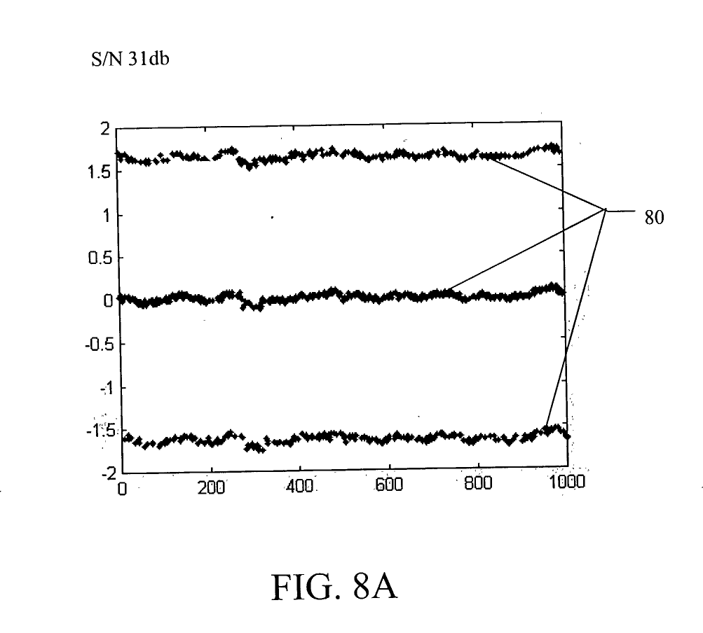

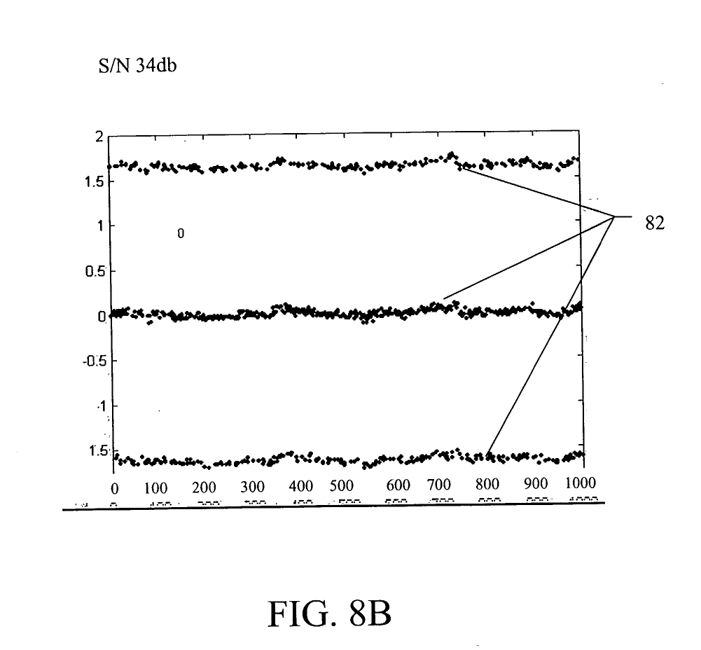

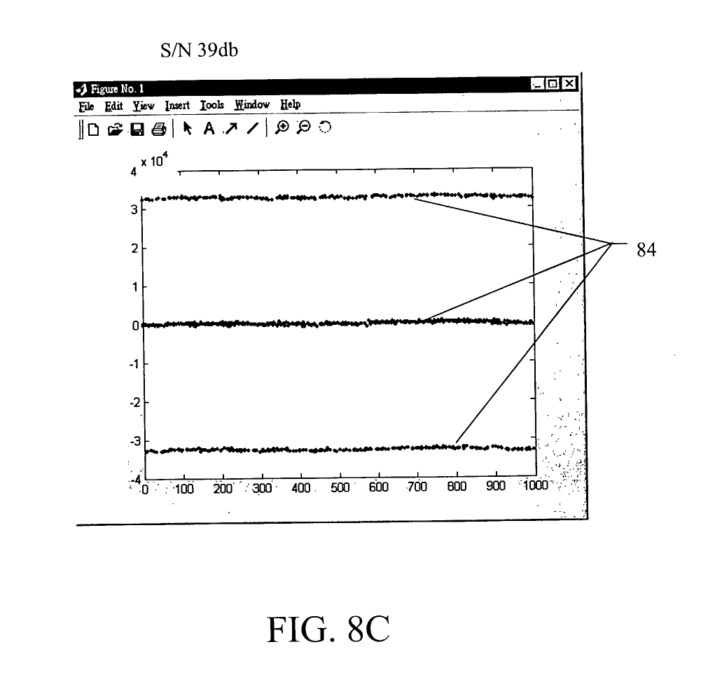

FIGS. 8A-8C are eye diagrams of an output signal that a receiver produces after receiving 1000 symbols. It is assumed that there is no channel effect and there are no killer packets, but there are small baseline wandering effect. FIG. 8A illustrates the output signal 80 from a receiver without any baseline wander correction circuit. The average value of the signal to noise ratio is 31 db. FIG. 8B illustrates the output signal 82 from a prior receiver according to Raghavan. The average value of the signal to noise ratio is 34 db. FIG. 8C illustrates the output signal 84 from a receiver according to the present invention. The average value of the signal to noise ratio is 39 db. Obviously, the receiver of the present invention. increases the signal to noise ratio. Because of higher signal to noise ratio and lower response time of the system, the saturation problem of the analog-to-digital converter when receiving “killer” packets will be overcome.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. A variation is to alter the symbol alphabet. The entire example discussed above involved a MLT3 symbol alphabet, but the invention is applicable to transceivers that utilize any symbol alphabet. Therefore, the scope of the appended claims should be accorded the broadest interpretation so as to encompass all such modifications and similar arrangements.

What is claimed is:

1. A receiver for baseline wandering compensation capable of correcting for baseline wander and receiving killer packets, comprising:
an analog-to-digital converter coupled to a transmission channel to receive and digitize input signals, the analog-to-digital converter outputting a sample;
an equalizer coupled to the analog-to-digital converter to receive the sample, the equalizer outputting an equalized sample;
a slicer coupled to the equalizer to receive the equalized sample, the slicer outputting a symbol based on the equalized sample output from the equalizer; and
a baseline wander corrector coupled between the slicer and the equalizer, wherein the baseline wander corrector receives the symbol output from the slicer and the equalized sample output from the equalizer, calculates a baseline correction, and adds the baseline correction to the equalized sample output from the equalizer.

2. The receiver as claimed in claim 1, wherein the equalizer comprises a feedforward equalizer and a decision feedback equalizer.

3. The receiver as claimed in claim 1, wherein the baseline wander corrector comprises:
a wander compensation circuit for receiving the symbol and the equalized sample and outputting a baseline correction signal with the baseline correction; and
an adder coupled between the slicer and the equalizer, wherein the adder receives the equalized sample output from the equalizer and the baseline correction signal output from the wander compensation circuit, and outputs a signal equal to the equalized sample output from the equalizer corrected by the baseline correction.

4. The receiver as claimed in claim 3, wherein the wander compensation circuit digitally implements a transfer function equal to K/(1−Z⁻¹), wherein K is a constant and Z⁻¹ represents a Z transform of a one period delay.

5. A receiver for baseline wandering compensation that is capable of correcting for baseline wander and receiving killer packets; wherein the receiver comprises an analog-to-digital converter, an equalizer coupled to the analog-to-digital converter to receive a sample output from analog-to-digital converter and outputting an equalized sample, and a slicer coupled to the equalizer to receive the equalized sample and outputting a symbol based on the equalized sample output from the equalizer; characterized in that:
the receiver further comprises a baseline wander corrector coupled between the slicer and the equalizer;
wherein the baseline wander corrector receives the symbol output from the slicer and the equalized sample output from the equalizer, calculates a baseline correction, and adds the baseline correction to the equalized sample output from the equalizer.

6. The receiver as claimed in claim 5, wherein the analog-to-digital converter is coupled to a transmission channel to receive and digitize input signals, and outputs the sample.

7. The receiver as claimed in claim 5, wherein the equalizer comprises a feedforward equalizer and a decision feedback equalizer.

8. The receiver as claimed in claim 5, wherein the baseline wander corrector comprises:
a wander compensation circuit for receiving the symbol and the equalized sample and outputting a baseline correction signal with the baseline correction; and
an adder coupled between the slicer and the equalizer, wherein the adder receives the equalized sample output from the equalizer and the baseline correction signal output from the wander compensation circuit, and outputs a signal equal to the equalized sample output from the equalizer corrected by the baseline correction.

9. The receiver as claimed in claim 8, wherein the wander compensation circuit digitally implements a transfer function equal to K/(1−Z⁻¹), wherein K is a constant and Z⁻¹ represents a Z transform of a one period delay.

10. A receiver for baseline wandering compensation that is capable of correcting for baseline wander and receiving killer packets, comprising:
an analog-to-digital converter coupled to a transmission channel to receive and digitize input signals, the analog-to-digital converter outputting a sample;
a feedforward equalizer coupled to the analog-to-digital converter to receive the sample, the feedforward equalizer outputting a feedforward-equalized sample;
a first adder having a first input terminal, a second input terminal and an output terminal, the first input terminal coupled to the feedforward equalizer, the output terminal outputting an equalized sample;
a slicer coupled to the output terminal of the first adder to receive the equalized sample, the slicer outputting a symbol based on the equalized sample;
a decision feedback equalizer coupled between the slicer and the second input terminal of the first adder, wherein the decision feedback equalizer receives the symbol output from the slicer and outputs a decision-equalized sample to the second input terminal of the first adder; and
a baseline wander corrector coupled between the slicer and the output terminal of the first adder, wherein the baseline wander corrector receives the symbol output from the slicer and the equalized sample output from the first adder, calculates a baseline correction, and adds the baseline correction to the equalized sample output from the first adder.

11. The receiver as claimed in claim 10, wherein the baseline wander corrector comprises:
a wander compensation circuit for receiving the symbol and the equalized sample and outputting a baseline correction signal with the baseline correction; and
a second adder coupled between the slicer and the first adder, wherein the second adder receives the equalized sample output from the first adder and the baseline correction signal output from the wander compensation circuit, and outputs a signal equal to the equalized sample output from the first adder corrected by the baseline correction.

12. The receiver as claimed in claim 11, wherein the wander compensation circuit digitally implements a transfer function equal to K/(1−Z⁻¹), wherein K is a constant and Z⁻¹ represents a Z transform of a one period delay.

13. The receiver as claimed in claim 11, wherein the decision feedback equalizer comprises the second adder of the baseline wander corrector.
